(19) United States
(12) Patent Application Publication
(10) Pub. No.: US 2026/0307942 A1
(43) Pub. Date: Oct. 8, 2026

(54) ELEVATOR GUIDE RAIL CLAMP AND METHOD OF USE

(71) Applicant: Wurtec, Incorporated, Toledo, OH (US)

(72) Inventors: Steven P. Wurth, Sylvania, OH (US); Christopher D. Blessing, Toledo, OH (US); Colton J. Hughson, La Salle, MI (US)

(21) Appl. No.: 19/642,043

(22) Filed: Apr. 8, 2026

Related U.S. Application Data
(60) Provisional application No. 63/785,177, filed on Apr. 8, 2025.

(51) Int. Cl. B66B 7/04; B66B 19/00

(52) U.S. Cl. CPC B66B 7/047; B66B 19/00

(57) ABSTRACT

An elevator clamp for use with a guide rail can include a framework having a framework cavity and a channel. The channel can be defined by a first wall, a second wall, and a base, and can receive the guide rail. A cam can be disposed in a recess in the first wall and can include an engagement portion and a clearance portion. A spring can bias the cam toward a first position in which the engagement portion extends into the channel to engage the guide rail. A handle can rotate the cam to a second position in which the engagement portion is retracted. A spring plunger can be disposed in the base and can provide a mechanical stop against cam rotation. Insertion of the guide rail can move the spring plunger to a compressed position, removing the mechanical stop and allowing the cam to engage the guide rail.

### CROSS-REFERENCE TO RELATED APPLICATIONS

This application claims the benefit of U.S. Provisional Application No. 63/785,177, filed on Apr. 8, 2025. The entire disclosure of the above application is incorporated herein by reference.

### FIELD

The present technology relates to elevator safety equipment, and more particularly, to an elevator clamp that can quickly and reliably engage a guide rail.

### INTRODUCTION

This section provides background information related to the present disclosure which is not necessarily prior art.

An elevator system can be found in buildings of varying heights and can be used to transport passengers and cargo between floors through an elevator car that travels along a guide rail within a hoistway. The guide rail can provide tracking and can maintain stability and alignment of the elevator car during operation. The guide rail, which can run vertically through the hoistway, can serve as a mounting point for temporary attachments during installation, maintenance, and various operational scenarios. The elevator system can use a machine-driven configuration where a powered device can drive a suspension element connected between the elevator car and a counterweight. The suspension element, such as a wire rope, can enable balanced movement within the hoistway as the counterweight moves in an opposing direction to the elevator car. Both the elevator car and the counterweight can travel in relation to a respective dedicated guide rail. The guide rail can be manufactured to precise dimensional tolerances and can be installed in a vertical orientation within the hoistway. The guide rail can also serve as a structural anchor for various components and devices that may need to be temporarily or permanently attached during the life of the elevator system.

An elevator installation can employ various mechanical and electronic components to control movement, including a governor, gearing, and a brake. Such mechanisms can involve complex components that can require regular maintenance and adjustment. A component or system may be used to secure an elevator car during installation, maintenance, or in response to an unexpected event or emergency, such as a fire. The complexity of such a system can contribute to increased maintenance requirements and potential points of failure during operation. During installation and maintenance, temporary securement of the elevator car to the guide rail can be desired. Such securement can allow a technician to work on the elevator system without risk of unintended car movement.

Certain securement systems can require multiple steps or tools to engage, which can introduce delays and potential for human error during installation or maintenance operations. The time required to properly engage a certain securement device can be a limiting factor in the efficiency of elevator installation and maintenance procedures. Likewise, certain securement systems may not effectively engage with a range of guide rail sizes and configurations that can be encountered in the field. Inconsistent engagement pressure can potentially lead to unreliable performance. Variability in engagement performance can be particularly problematic in an emergency scenario where rapid and reliable securement of the elevator car is desired.

Devices and systems used to secure an elevator car to a guide rail can require a manual multi-step engagement procedure that can increase the likelihood of improper installation or use. Such devices may depend on the operator to complete each step in a precise sequence for proper engagement with the guide rail. If a step in the engagement sequence can be skipped or improperly performed, the securement device may fail to engage the guide rail reliably. The potential for operator error in a certain multi-step securement system can represent a limitation on the reliability and safety of elevator installation and maintenance operations.

Devices and systems used to secure an elevator car to a guide rail can lack a mechanism to militate against premature engagement before the guide rail can be properly positioned within the clamping portion. Premature engagement can result in misalignment between the clamping portion and the guide rail, potentially leading to incomplete or unreliable securement. Additionally, certain designs may not accommodate guide rails of varying size without the use of a separate tool or complete replacement of the clamping portion. The inability to adapt to a varying guide rail size can limit the utility of a certain clamp designs across different elevator installations.

Devices and systems used to secure an elevator car to a guide rail can be heavy and cumbersome, making handling and positioning during installation and maintenance more difficult. The weight of the device can contribute to operator fatigue and can increase the time required to position and engage the device on the guide rail. Additionally, the device may not provide tactile or mechanical feedback to confirm proper engagement with the guide rail, leaving the operator uncertain as to whether securement has been achieved. The lack of engagement confirmation in the device can represent a limitation on the reliability of such a device in practical use.

Accordingly, there is a continuing need for an elevator clamp that can reliably and rapidly engage a guide rail without requiring a complex multi-step manual procedure, that can accommodate guide rails of varying sizes, and that can provide a positive mechanical indication of proper engagement. Desirably, such an elevator clamp can be lightweight, can minimize the potential for operator error, can militate against premature engagement prior to proper positioning on the guide rail, and can deliver consistent and reliable engagement across a range of guide rail sizes and operating conditions.

### SUMMARY

In concordance with the instant disclosure, an elevator clamp that can reliably and rapidly engage a guide rail without requiring a complex multi-step manual procedure, that can accommodate a guide rail of varying sizes, and that can provide a positive mechanical indication of proper engagement, has surprisingly been discovered. The present technology includes articles of manufacture, systems, and processes that relate to an elevator clamp that can automatically engage a guide rail upon insertion of the guide rail.

In certain embodiments, an elevator clamp for use with a guide rail is provided. The elevator clamp can include a framework including a framework cavity and a channel, the channel defined by a first wall, a second wall facing the first wall, and a base spacing the first wall from the second wall, the channel adapted to receive the guide rail. A recess can be formed in the first wall, and a cam can be disposed in the recess, the cam including a cam cavity, an engagement portion, and a clearance portion. A spring can include a first portion disposed in the cam cavity and a second portion disposed in the framework cavity, the spring having a first end engaging the cam and a second end engaging the framework, the spring biasing the cam toward a first position in which the engagement portion is rotated into the channel. A handle can rotate the cam from the first position to a second position in which the engagement portion is rotated out of the channel. A spring plunger can be disposed in the base of the framework, the spring plunger compressible between an extended position and a compressed position, the spring plunger in the extended position providing a mechanical stop against rotation of the cam toward the first position, and the spring plunger in the compressed position permitting rotation of the cam toward the first position. The spring plunger can be moved to the compressed position by insertion of the guide rail into the channel, thereby removing the mechanical stop and allowing the spring to rotate the cam to the first position to engage the guide rail.

In certain embodiments, a method of using an elevator clamp with a guide rail is provided. The method can include providing the elevator clamp and positioning the elevator clamp on the guide rail such that the guide rail is received within the channel. The guide rail can move the spring plunger to the compressed position, thereby removing the mechanical stop and allowing the spring to rotate the cam to the first position to engage the guide rail against the second wall.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is an exploded view of an elevator clamp, according to an embodiment of the present disclosure;

FIG. 2 is a top perspective view of the elevator clamp, according to the embodiment shown in FIG. 1;

FIG. 3 is a rear perspective view of the elevator clamp, according to the embodiment shown in FIG. 1;

FIG. 4 is a right-side elevational view of the elevator clamp, according to the embodiment shown in FIG. 1;

FIG. 5 is a top perspective view of a framework of the elevator clamp, according to the embodiment shown in FIG. 1;

FIG. 6 is a top plan view of the framework of the elevator clamp, according to the embodiment shown in FIG. 1;

FIG. 7 is a top perspective view of a cam of the elevator clamp, according to the embodiment shown in FIG. 1;

FIG. 8 is a bottom perspective view of the cam of the elevator clamp, according to the embodiment shown in FIG. 1;

FIG. 9 is a top perspective view of a first spacer, a second spacer, and a third spacer of the elevator clamp, according to the embodiment shown in FIG. 1;

FIG. 10 is a top perspective view of the elevator clamp with a cam and a handle in a first position, where an engagement portion of the cam is rotated into a channel and a spring plunger is in a compressed position, according to an embodiment of the present disclosure;

FIG. 11 is a top perspective view of the elevator clamp with the cam and the handle in a second position, where the engagement portion of the cam is rotated into a recess and the spring plunger is in an extended position, according to the embodiment shown in FIG. 10;

FIG. 12 is a top plan view of the elevator clamp with a cam and a handle in a first position, where an engagement portion of the cam is rotated into a channel and a spring plunger is in a compressed position, according to an embodiment of the present disclosure

FIG. 13 is a top plan view of the elevator clamp with the cam and the handle in a second position, where the engagement portion of the cam is rotated into a recess and the spring plunger is in an extended position, according to the embodiment shown in FIG. 12; and

FIG. 14 is a flow chart illustrating a method of using an elevator clamp with a guide rail, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

An elevator clamp is provided that can include a framework having a channel that can receive a guide rail of an elevator system. A cam can be disposed in a recess formed in a wall of the framework, the cam having an engagement portion and a clearance portion. A spring can bias the cam toward a first position in which the engagement portion extends into the channel. A handle can rotate the cam from the first position to a second position in which the engagement portion is retracted from the channel, allowing a spring plunger disposed in the base of the framework to move to an extended position where it can act as a mechanical stop against rotation of the cam. When the elevator clamp is positioned on the guide rail, the guide rail can move the spring plunger to a compressed position, thereby removing the mechanical stop and allowing the spring to automatically rotate the cam to the first position to engage the guide rail against a second wall of the channel. The elevator clamp can also include a spacer removably disposed in the channel to adapt the channel to a predetermined guide rail size, a detent mechanism including a ball bearing disposed on a biasing element to reduce friction during handle actuation, and a cap disposed on the first wall including slots for receiving the handle and a handle spacer.

The elevator clamp can provide a rapid and reliable means of securing an elevator car to a guide rail without requiring a complex multi-step manual procedure. Once the handle is rotated to arm the device, the elevator clamp can automatically engage the guide rail upon positioning of the clamp on the rail, reducing the potential for operator error and decreasing the time required for installation. The spring plunger can provide a positive mechanical indication of proper arming by rising to the extended position, giving the operator confirmation that the device is ready for engagement. The spacer system can allow the elevator clamp to accommodate a guide rail of varying sizes without requiring a separate tool or complete replacement of the clamp. The elevator clamp can also be lightweight, reducing operator fatigue during installation and maintenance operations in an elevator hoistway.

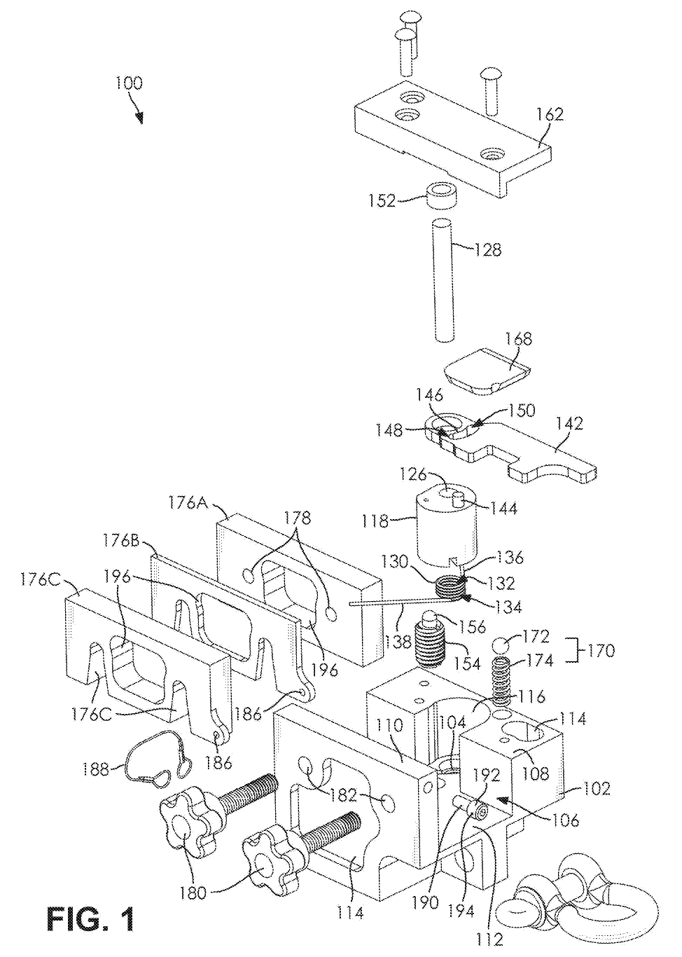

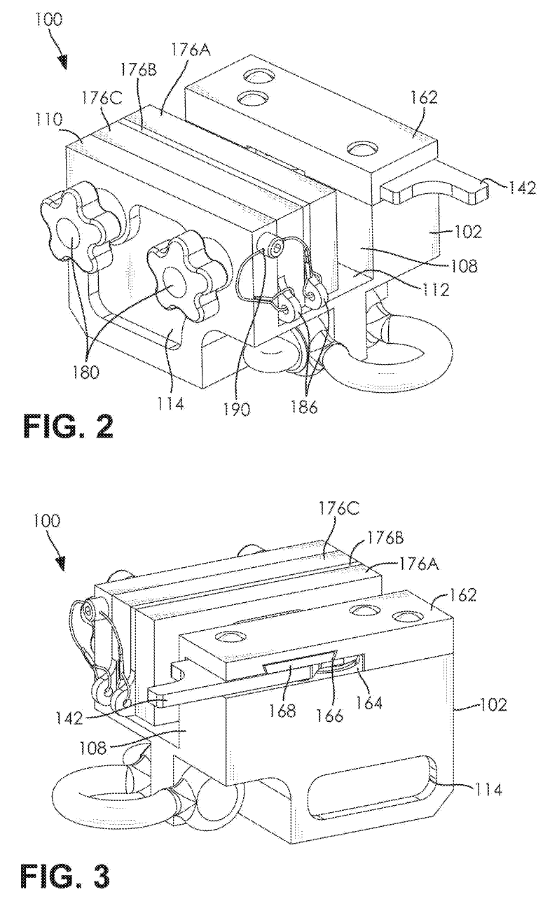

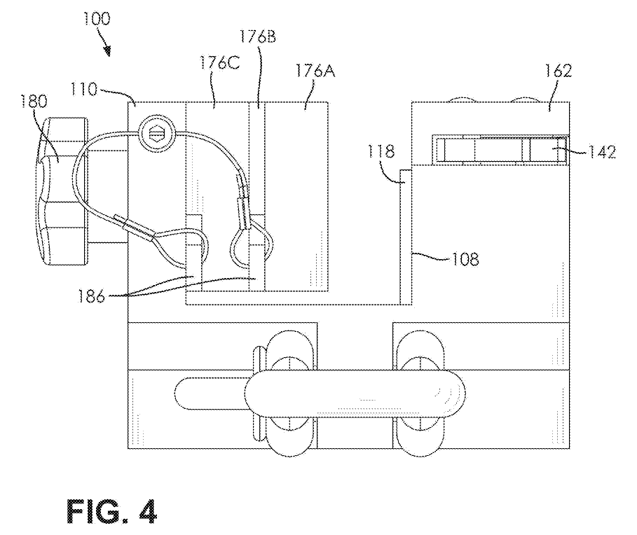

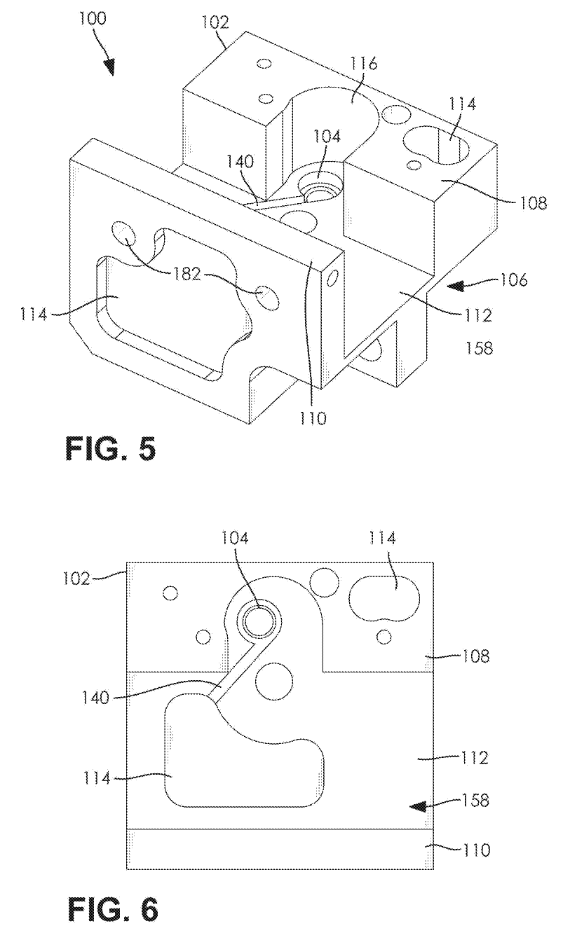

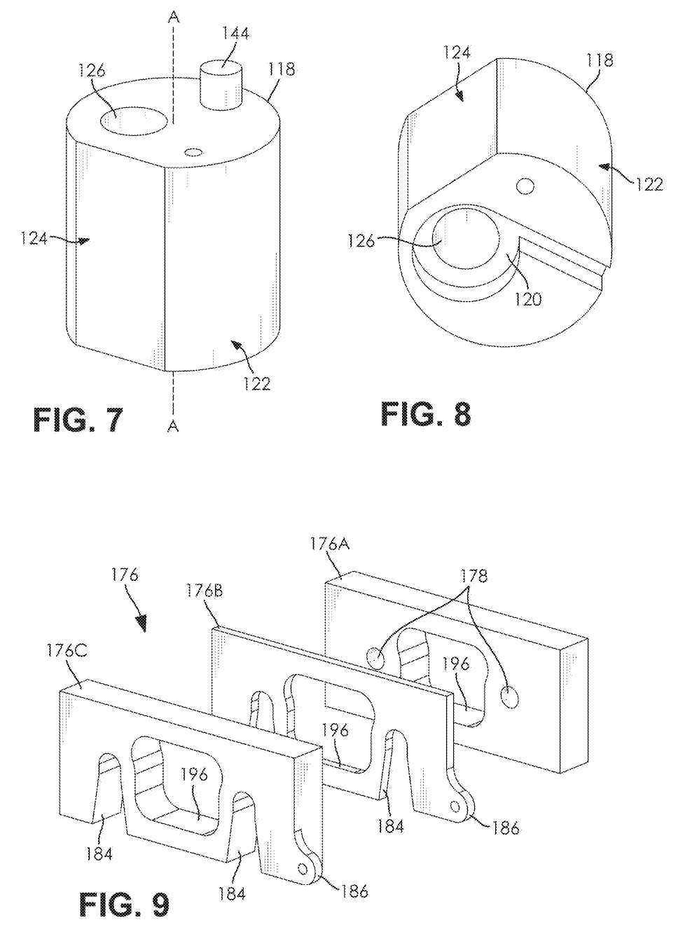

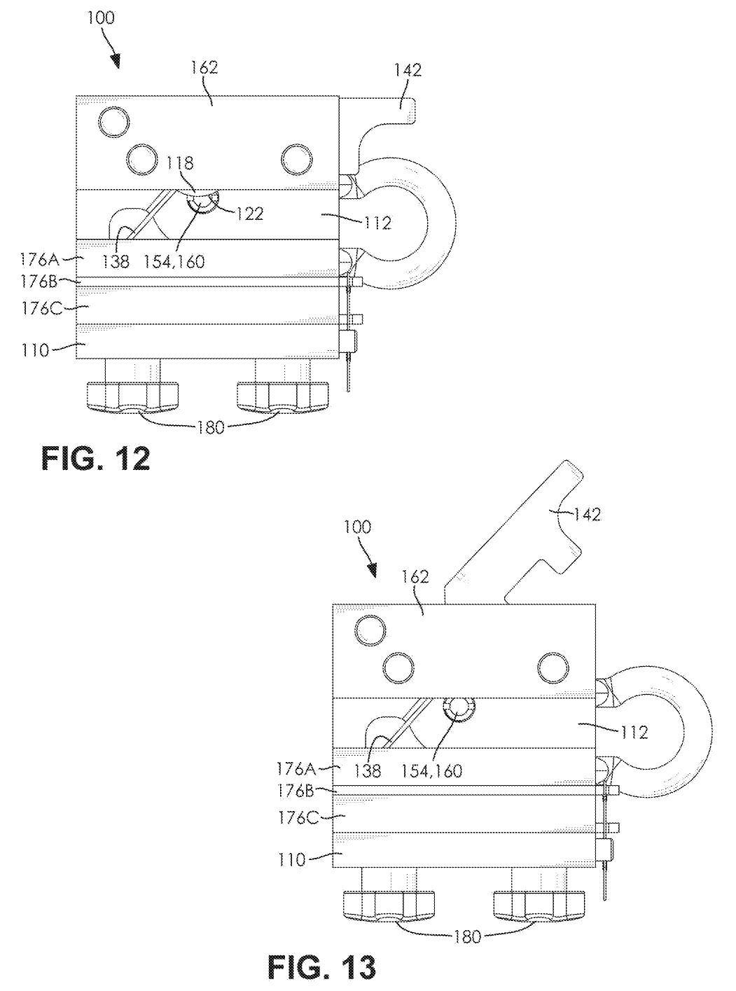

Referring now to FIGS. 1-13, an embodiment of an elevator clamp 100 for use with a guide rail (not shown) is provided. The elevator clamp 100 can be used in an elevator hoistway during installation, maintenance, or other operational scenarios where temporary securement of an elevator car or counterweight to a guide rail is desired. The elevator clamp 100 can be selectively movable between a first position and a second position, as described in greater detail herein.

With reference to FIGS. 1 and 4-6, in certain embodiments, the elevator clamp 100 can include a framework 102. The framework 102 can provide structural support for the components of the elevator clamp 100. The framework 102 can include a framework cavity 104 and a channel 106. The channel 106 can be defined by a first wall 108, a second wall 110 facing the first wall 108, and a base 112 spacing the first wall 108 from the second wall 110. The first wall 108, the second wall 110, and the base 112 together form a substantially U-shaped profile. The framework 102 can be formed from a variety of materials including aluminum, steel, a composite material, and combinations thereof.

In certain embodiments, the framework 102 can include a cutout 114 formed therein. The cutout 114 can be configured to reduce the weight of the framework 102. In certain embodiments, the cutout 114 can include a plurality of cutouts 114 distributed throughout the framework 102 to reduce the weight of the framework 102 while maintaining structural integrity.

In certain embodiments, a recess 116 can be formed in the first wall 108. The recess 116 can extend from the channel 106. The recess 116 can have an arcuate shape that can generally correspond to a circumferential surface of the cam 118 to allow controlled rotation of the cam 118 while maintaining proper alignment of the cam 118 within the recess 116.

With reference to FIGS. 1, 7-8, and 10-13, in certain embodiments, a cam 118 can be disposed in the recess 116. The cam 118 can include a cam cavity 120, an engagement portion 122, and a clearance portion 124. The cam 118 can have a cylindrical body with the clearance portion 124 defined by a planar flat formed on the cylindrical body. The engagement portion 122 can be defined by the curved cylindrical surface of the cam 118. In the first position the engagement portion 122 can be rotated into the channel 106 to engage the guide rail. In the second position the engagement portion 122 can be rotated out of the channel 106 and into the recess 116, with the clearance portion 124 facing the channel 106 to permit free insertion of the guide rail.

The cam 118 can include an aperture 126 configured to receive a shaft 128. The aperture 126 can be offset from a central axis of the cam 118 such that the cam 118 rotates eccentrically about the shaft 128. The eccentric relationship between the aperture 126 and the central axis of the cam 118 can cause the engagement portion 122 to sweep into the channel 106 upon rotation of the cam 118 toward the first position, progressively increasing the engagement force between the engagement portion 122 and the guide rail as load is applied to the elevator clamp 100.

The elevator clamp 100 can include a shaft 128 extending through the cam 118. The shaft 128 can be coupled to the framework 102 and can define a rotational axis of the cam 118. A spring 130 can be disposed around the shaft 128 within the cam cavity 120 and the framework cavity 104.

The spring 130 can include a first portion 132 and a second portion 134. The first portion 132 can be disposed in the cam cavity 120 and the second portion 134 can be disposed in the framework cavity 104. The spring 130 can have a first end 136 engaging the cam 118 and a second end 138 engaging the framework 102. The spring 130 can bias the cam 118 toward the first position in which the engagement portion 122 is rotated into the channel 106. In one non-limiting embodiment the spring 130 can be a torsion spring. The framework 102 can include a spring cutout 140 extending from the framework cavity 104. The spring cutout 140 can be configured to retain the second end 138 of the spring 130. The spring cutout 140 can engage the second end 138 of the spring 130 to provide a reaction point against which the spring 130 can exert its biasing force on the cam 118.

In certain embodiments, the elevator clamp 100 can include a handle 142. The handle 142 can be configured to rotate the cam 118 from the first position to the second position in which the engagement portion 122 is rotated out of the channel 106. In one non-limiting embodiment the handle 142 can be constructed from high strength steel to resist bending forces during operation. A pin 144 can be coupled to the cam 118 and a pin aperture 146 formed in the handle 142. The pin aperture 146 can have a first end 148 and a second end 150. Rotation of the handle 142 can cause the first end 148 of the pin aperture 146 to engage the pin 144 to rotate the cam 118 from the first position to the second position. In certain embodiments, the pin aperture 146 can be arcuate. The handle 142 can include a bearing 152 configured to allow the handle 142 to rotate independently of the shaft 128. The bearing 152 can rotationally decouple the handle 142 from the shaft 128 such that rotation of the handle 142 does not cause rotation of the shaft 128. The shaft 128 can therefore remain stationary while the handle 142 rotates, with the cam 118 being rotated through the engagement of the first end 148 of the pin aperture 146 with the pin 144.

In certain embodiments, and as illustrated in FIGS. 1 and 10-13, the elevator clamp 100 can include a spring plunger 154 disposed in the base 112 of the framework 102. The spring plunger 154 can be compressible between an extended position and a compressed position. The spring plunger 154 in the extended position can provide a mechanical stop 160 against rotation of the cam 118 toward the first position. The spring plunger 154 in the compressed position can permit rotation of the cam 118 toward the first position. In the compressed position a nose 156 of the spring plunger 154 can be at or below a surface 158 of the base 112. In the extended position the nose 156 can project above the surface 158 of the base 112 to act as the mechanical stop 160. When the elevator clamp 100 is positioned on the guide rail, the guide rail can move the spring plunger 154 to the compressed position, thereby removing the mechanical stop 160 and allowing the spring 130 to rotate the cam 118 to the first position to engage the guide rail against the second wall 110.

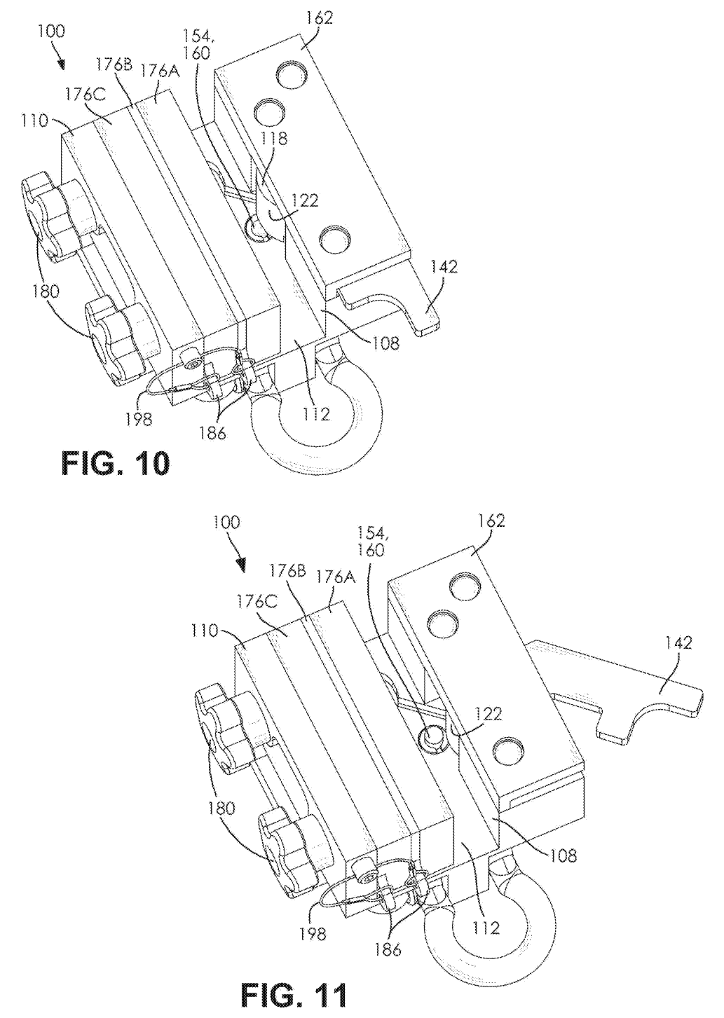

In certain embodiments, and as illustrated in FIGS. 10-13, the first position of the cam 118 can correspond to a storage state when no guide rail is present in the channel 106 and an engaged state when the guide rail is present in the channel 106 and engaged against the second wall 110. In the storage state the engagement portion 122 can be rotated into the channel 106 and the spring plunger 154 can be in the compressed position. In the engaged state the engagement portion 122 can be rotated into the channel 106 and can bear against the guide rail to engage the guide rail against the second wall 110. The second position of the cam 118 can correspond to an armed state in which the spring plunger 154 can be in the extended position acting as the mechanical stop 160 and the spring 130 can be loaded in anticipation of guide rail insertion. In the armed state the engagement portion 122 can be rotated out of the channel 106 and the clearance portion 124 can face the channel 106 to permit free insertion of the guide rail.

In certain embodiments, and as illustrated in FIGS. 1-4 and 10-13, the elevator clamp 100 can include a cap 162 disposed on the first wall 108. The cap 162 can include a first slot 164 configured to receive the handle 142 and a second slot 166 configured to receive a handle spacer 168. The handle spacer 168 can be configured to limit contact between the handle 142 and the cap 162 during movement of the handle 142 between the first position and the second position. The first slot 164 can be configured to guide rotation of the handle 142 between the first position and the second position.

In certain embodiments, and as illustrated in FIG. 1, the elevator clamp 100 can include a detent mechanism 170. The detent mechanism 170 can include a ball bearing 172 disposed on a biasing element 174. The biasing element 174 can be a spring. The biasing element 174 can urge the ball bearing 172 into engagement with the handle 142 during movement of the handle 142 between the first position and the second position. The ball bearing 172 can be configured to rotate relative to the handle 142 to reduce friction during rotation of the cam 118 from the first position to the second position.

In certain embodiments, and as illustrated in FIGS. 1-4 and 9-13, the elevator clamp 100 can include a spacer 176 removably disposed in the channel 106. The spacer 176 can be configured to adapt the channel 106 to a predetermined guide rail size. In certain embodiments the spacer 176 can include a first spacer 176A, a second spacer 176B, and a third spacer 176C. The first spacer 176A can be disposed closest to the cam 118 and the first wall 108. The second spacer 176B and the third spacer 176C can be disposed between the first spacer 176A and the second wall 110.

The first spacer 176A can include a receptacle 178 configured to receive a fastener 180 extending through an aperture 182 in the second wall 110. The fastener 180 can operate to couple the first spacer 176A to the second wall 110. The second spacer 176B and the third spacer 176C can each include a slot 184 configured to receive the fastener 180. The slot 184 can permit removal of the second spacer 176B and the third spacer 176C upon loosening of the fastener 180 without requiring full removal of the fastener 180 from the second wall 110. This can allow quick adaptation of the channel 106 to accommodate a guide rail of a different size.

The second spacer 176B and the third spacer 176C can each include an eyelet 186 configured to receive a tether 188. The tether 188 can couple the second spacer 176B and the third spacer 176C to the framework 102 to militate against the second spacer 176B and the third spacer 176C from being dropped into the elevator hoistway during installation or maintenance. The tether 188 can be coupled to the framework 102 by a tether fastener 190. The tether fastener 190 can have a head 192 with an aperture 194 configured to receive the tether 188. The second spacer 176B and the third spacer 176C can each include a cutout 196 formed therein. The cutout 196 can be configured to reduce the weight of each respective spacer. In certain embodiments the cutout 196 can include a plurality of cutouts 196 to reduce the weight of each respective spacer while maintaining structural integrity.

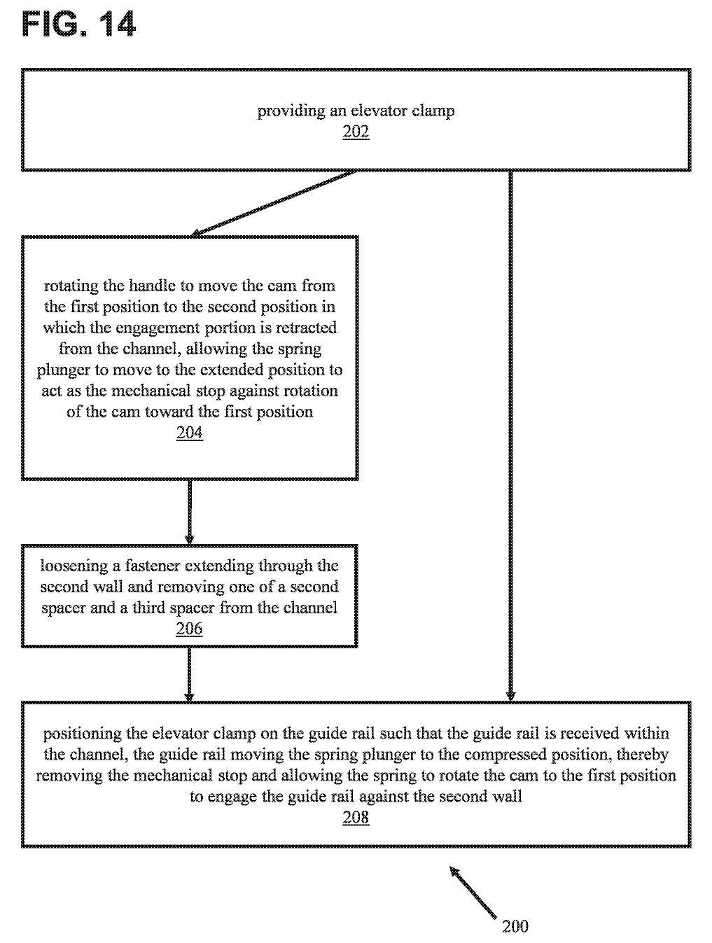

With reference to FIG. 14, in certain embodiments, a method 200 of using the elevator clamp 100 with a guide rail can be provided. The elevator clamp 100 can be the elevator clamp 100 as described herein. The elevator clamp 100 can be positioned on the guide rail such that the guide rail can be received within the channel 106. The guide rail can move the spring plunger 154 to the compressed position, thereby removing the mechanical stop 160 and allowing the spring 130 to rotate the cam 118 to the first position to engage the guide rail against the second wall 110.

In certain embodiments, prior to positioning the elevator clamp 100 on the guide rail, the handle 142 can be rotated to move the cam 118 from the first position to the second position in which the engagement portion 122 can be rotated out of the channel 106. Rotation of the handle 142 to the second position can allow the spring plunger 154 to move to the extended position to act as the mechanical stop 160 against rotation of the cam 118 toward the first position. The spring 130 can be loaded in the second position in anticipation of guide rail insertion.

In certain embodiments, prior to positioning the elevator clamp 100 on the guide rail, a fastener 180 extending through the second wall 110 can be loosened and one of the second spacer 176B and the third spacer 176C can be removed from the channel 106 to adapt the channel 106 to a predetermined guide rail size. Removal of one of the second spacer 176B and the third spacer 176C can include sliding one of the second spacer 176B and the third spacer 176C out of the channel 106 through the slot 184 formed in one of the second spacer 176B and the third spacer 176C without fully removing the fastener 180 from the second wall 110.

The elevator clamp 100 can advantageously provide a reliable and rapid means of engaging a guide rail without requiring a complex multi-step manual procedure, thereby reducing the potential for operator error and decreasing the time required for installation and maintenance operations. The spring plunger 154 can militate against premature engagement of the cam 118 before the guide rail can be properly positioned within the channel 106, and upon proper positioning of the elevator clamp 100 on the guide rail, the elevator clamp 100 can automatically engage the guide rail through the action of the spring 130, providing a positive mechanical indication of proper engagement without requiring additional steps by the operator. The spacer 176 system can allow the elevator clamp 100 to accommodate guide rails of varying sizes without requiring a separate tool or complete replacement of the elevator clamp 100, enhancing the utility of the elevator clamp 100 across different elevator installations. The framework 102 can be constructed from a lightweight material such as aluminum, reducing operator fatigue during handling and positioning of the elevator clamp 100 within the elevator hoistway. The detent mechanism 170 can provide tactile feedback to the operator during rotation of the handle 142, confirming that the elevator clamp 100 can be properly transitioned between the first position and the second position, thereby addressing the limitation of certain devices that can lack a mechanism to confirm proper engagement with the guide rail.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An elevator clamp for use with a guide rail, the elevator clamp comprising:
a framework including a framework cavity and a channel, the channel defined by a first wall, a second wall facing the first wall, and a base spacing the first wall from the second wall, the channel configured to receive the guide rail;
a recess formed in the first wall;
a cam disposed in the recess, the cam including a cam cavity, an engagement portion, and a clearance portion;
a spring including a first portion and a second portion, the first portion disposed in the cam cavity and the second portion disposed in the framework cavity, the spring having a first end engaging the cam and a second end engaging the framework, the spring biasing the cam toward a first position in which the engagement portion is rotated into the channel;
a handle configured to rotate the cam from the first position to a second position in which the engagement portion is rotated out of the channel; and
a spring plunger disposed in the base of the framework, the spring plunger compressible between an extended position and a compressed position, the spring plunger in the extended position providing a mechanical stop against rotation of the cam toward the first position, the spring plunger in the compressed position permitting rotation of the cam toward the first position, the spring plunger configured to be moved to the compressed position by insertion of the guide rail into the channel, thereby removing the mechanical stop and allowing the spring to rotate the cam to the first position and engage the guide rail.

2. The elevator clamp of claim 1, wherein:
the first position corresponds to a storage state when no guide rail is present in the channel and an engaged state when the guide rail is present in the channel and engaged against the second wall, and
the second position corresponds to an armed state in which the spring plunger is in the extended position acting as the mechanical stop and the spring is loaded in anticipation of guide rail insertion.

3. The elevator clamp of claim 1, wherein a nose of the spring plunger is at or below a surface of the base in the compressed position and the nose projects above the surface of the base to act as the mechanical stop in the extended position.

4. The elevator clamp of claim 1, wherein the framework includes a spring cutout extending from the framework cavity, the spring cutout configured to retain the second end of the spring.

5. The elevator clamp of claim 1, further comprising a pin coupled to the cam and a pin aperture formed in the handle, the pin aperture having a first end and a second end, wherein rotation of the handle causes the first end of the pin aperture to engage the pin to rotate the cam from the first position to the second position.

6. The elevator clamp of claim 5, wherein the pin aperture is arcuate.

7. The elevator clamp of claim 1, further comprising a spacer removably disposed in the channel, the spacer configured to adapt the channel to a predetermined guide rail size.

8. The elevator clamp of claim 7, wherein the spacer is comprised by a first spacer, a second spacer, and a third spacer.

9. The elevator clamp of claim 8, wherein the first spacer includes a receptacle configured to receive a fastener extending through an aperture in the second wall, the fastener operating to couple the first spacer to the second wall.

10. The elevator clamp of claim 9, wherein the second spacer and the third spacer each include a slot configured to receive the fastener and permit removal of the second spacer and the third spacer upon loosening of the fastener.

11. The elevator clamp of claim 10, wherein the second spacer and the third spacer each include an eyelet configured to receive a tether for coupling the second spacer and the third spacer to the framework.

12. The elevator clamp of claim 11, wherein the tether is coupled to the framework by a tether fastener, the tether fastener having a head with an aperture configured to receive the tether.

13. The elevator clamp of claim 1, further comprising a detent mechanism including a ball bearing disposed on a biasing element, the biasing element urging the ball bearing into engagement with the handle during movement of the handle between the first position and the second position, the ball bearing configured to rotate relative to the handle to reduce friction during rotation of the cam from the first position to the second position.

14. The elevator clamp of claim 1, further comprising a cap disposed on the first wall, the cap including a first slot configured to receive the handle and a second slot configured to receive a handle spacer, the handle spacer configured to limit contact between the handle and the cap during movement of the handle between the first position and the second position.

15. The elevator clamp of claim 1, further comprising a shaft extending through the cam, the shaft coupled to the framework and defining a rotational axis of the cam.

16. The elevator clamp of claim 15, wherein the cam includes an aperture configured to receive the shaft, the aperture being offset from a central axis of the cam.

17. The elevator clamp of claim 16, wherein the spring is disposed around the shaft.

18. The elevator clamp of claim 17, wherein the handle includes a bearing configured to allow the handle to rotate independently of the shaft.

19. An elevator clamp for use with a guide rail, the elevator clamp comprising:
a framework including a framework cavity and a channel, the channel defined by a first wall, a second wall facing the first wall, and a base spacing the first wall from the second wall, the channel configured to receive the guide rail;
a recess formed in the first wall;
a cam disposed in the recess, the cam including a cam cavity, an engagement portion, and a clearance portion;
a spring including a first portion and a second portion, the first portion disposed in the cam cavity and the second portion disposed in the framework cavity, the spring having a first end engaging the cam and a second end engaging the framework, the spring biasing the cam toward a first position in which the engagement portion is rotated into the channel;
a handle configured to rotate the cam from the first position to a second position in which the engagement portion is rotated out of the channel;
a spring plunger disposed in the base of the framework, the spring plunger compressible between an extended position and a compressed position, the spring plunger in the extended position providing a mechanical stop against rotation of the cam toward the first position, the spring plunger in the compressed position permitting rotation of the cam toward the first position, the spring plunger configured to be moved to the compressed position by insertion of the guide rail into the channel, thereby removing the mechanical stop and allowing the spring to rotate the cam to the first position and engage the guide rail;
a pin coupled to the cam and a pin aperture formed in the handle, the pin aperture having a first end and a second end, wherein rotation of the handle causes the first end of the pin aperture to engage the pin to rotate the cam from the first position to the second position;
a spacer removably disposed in the channel, the spacer configured to adapt the channel to a predetermined guide rail size;
a detent mechanism including a ball bearing disposed on a biasing element, the biasing element urging the ball bearing into engagement with the handle during movement of the handle between the first position and the second position, the ball bearing configured to rotate relative to the handle to reduce friction during rotation of the cam from the first position to the second position;
a cap disposed on the first wall, the cap including a first slot configured to receive the handle and a second slot configured to receive a handle spacer, the handle spacer is configured to limit contact between the handle and the cap during movement of the handle between the first position and the second position; and
a shaft extending through the cam, the shaft coupled to the framework and defining a rotational axis of the cam,
wherein:
the framework includes a cutout formed therein, the cutout configured to reduce weight of the framework,
the cutout includes a plurality of cutouts,
the first position corresponds to a storage state when no guide rail is present in the channel and an engaged state when the guide rail is present in the channel and engaged against the second wall,
the second position corresponds to an armed state in which the spring plunger is in the extended position acting as the mechanical stop and the spring is loaded in anticipation of guide rail insertion,
a nose of the spring plunger is at or below a surface of the base in the compressed position and the nose projects above the surface of the base to act as the mechanical stop in the extended position,
the framework includes a spring cutout extending from the framework cavity, the spring cutout configured to retain the second end of the spring,
the pin aperture is arcuate,
the spacer is comprised by a first spacer, a second spacer, and a third spacer,
the first spacer includes a receptacle configured to receive a fastener extending through an aperture in the second wall, the fastener operating to couple the first spacer to the second wall,
the second spacer and the third spacer each include a slot configured to receive the fastener and permit removal of the second spacer and the third spacer upon loosening of the fastener,
the second spacer and the third spacer each include an eyelet configured to receive a tether for coupling the second spacer and the third spacer to the framework,
the tether is coupled to the framework by a tether fastener, the tether fastener having a head with an aperture configured to receive the tether,
the second spacer and the third spacer each include a cutout formed therein, the cutout configured to reduce a weight of each respective spacer,
the cutout includes a plurality of cutouts,
the cam includes an aperture configured to receive the shaft, the aperture being offset from a central axis of the cam,
the spring is disposed around the shaft, and
the handle includes a bearing configured to allow the handle to rotate independently of the shaft.

20. A method of using an elevator clamp with a guide rail, the method comprising:
providing the elevator clamp of claim 1; and
positioning the elevator clamp on the guide rail such that the guide rail is received within the channel, the guide rail moving the spring plunger to the compressed position, thereby removing the mechanical stop and allowing the spring to rotate the cam to the first position to engage the guide rail against the second wall.
